(19) United States
(12) Patent Application Publication
(10) Pub. No.: US 2003/0038754 A1
(43) Pub. Date: Feb. 27, 2003

(54) Method and apparatus for gaze responsive text presentation in RSVP display

(76) Inventors: Mikael Goldstein, Stockholm (SE); Bj?ouml;rn Jonsson, J?auml;rf?auml;lla (SE); Per-Olof Nerbrant, Ostersk?auml;r (SE)

Correspondence Address: James O. Skarsten, Jenkens & Gilchrist, P.C., Suite 3200, 1445 Ross Avenue, Dallas, TX, 75202-2799, US

(21) Appl. No.: 09/938,087

(22) Filed: Aug. 22, 2001

(51) Int. Cl. G09G 5/00

(52) U.S. Cl. 345/7

(57) ABSTRACT

Method and apparatus is provided for use with a rapid serial visual presentation (RSVP) display window in a mobile communication device to selectively adjust the presentation of text. Eye tracking sensors are used to detect when a reader's focus shifts outside the text window, indicating that the reader has become inattentive to displayed text. Thereupon, presentation of text is halted. When the eye tracking sensors detect that the focus of the reader's eyes has shifted back into the text window, text presentation is resumed. Usefully, the rate of text presentation is slowed down or speeded up, when the eye tracking sensors detect the reader's eyes to be focused on the left edge or on the right edge, respectively, of the text display window.

### BACKGROUND OF THE INVENTION

The invention disclosed and claimed herein generally pertains to a method and apparatus for adjusting the presentation of text in a Rapid Serial Visual Presentation (RSVP) display. More particularly, the invention perta ins to a method of the above type wherein text presentation is started and stopped and the speed thereof may be varied, according to a reader's point of gaze, that is, the direction or point at which his eyes are focused with respect to the display. Even more particularly, the invention pertains to a method of the above type wherein a reader's point of gaze is continually monitored, and text presentation is continually adjusted in accordance therewith.

Mobile devices such as mobile phones and Personal Digital Assistant (PDAs), are increasingly being used to directly acquire information, in the form of electronic text, from sources such as the Internet. The usability of such mobile devices should preferably match or surpass usability of stationary desktop computers, so that all tasks that can be accomplished in the stationary office environment can likewise be accomplished in the mobile context. Notwithstanding differences between the two types of devices in size and weight, screen size, and computational power and software complexity, it is anticipated that in time the mobile devices will have substantially the same features as stationary computers. Accordingly, the pace of information retrieval for the mobile user should match or surpass that of the stationary user.

Presentation of text for reading is possibly the most important issue regarding the usability of mobile devices in acquiring information from the Internet or like electronic sources. An important consideration is the comparatively small size of the window used for displaying text in a mobile device of the above type. Typically, this window is no greater than 1½ inches in length, in contrast to the large electronic screen of a stationary desktop computer. Accordingly, an RSVP technique was developed for mobile devices, wherein segments of text are sequentially presented on the display window, in a single row and for a fixed exposure time, until a complete message has been communicated. By using RSVP, it is possible to maintain the same reading speed and comprehension level in reading long text from a 1-line display of a PDA, as in reading the same text from paper. However, it has been found that cognitive demands associated with reading text by means of such RSVP technique, as measured by the NASA-TLX (Task Load Index) were far greater than when reading from paper.

In view of these drawbacks a modified technique known as adaptive RSVP was developed, which takes into account factors which include difficulty of the text, sentence length, the number of characters presented in an RSVP segment, and individual word length and frequency. Thus, instead of presenting each segment of text according to a fixed exposure time linked to a selected reading pace of words per minute, successive text segments in adaptive RSVP are presented at a variable exposure time, normally distributed around the mean exposure time for a selected reading pace. Thus, adaptive RSVP models an aspect of the paper reading process onto the electronic interface. More specifically, a user is able to focus on different words for different amounts of time, depending on whether the word is long or short, whether it occurs frequently or infrequently, and whether it is located at the beginning or end of a sentence.

In order to provide a convenient interface suitable for reading electronic text, given the constraint of the small 1½ inch display typically available in a mobile device, it is important to model the user's normal behavior when reading from paper. If any of the characteristics or affordances encountered in reading from a paper interface is not modeled properly or is lacking in connection with the electronic interface, the user will perceive this as a drawback. Adaptive RSVP models one affordance of paper reading into the electronic 1-line RSVP display interface, by varying the presentation times of different text segments as described above. However, there are other affordances of paper reading that have not previously been modeled into the electronic RSVP interface. One very significant affordance in reading a paper document is that the reader can interrupt the reading process whenever he wants, for any reason, and for any length of time. For example, the reader may be distracted by something completely unrelated to the text being read. Alternatively, the text may stimulate the reader to thought which causes temporary inattention to the remainder of the text. However, the text remains fixed on the paper document, and the reader can at any time resume reading, at the place where he had left off.

The RSVP electronic reading paradigm does not provide this affordance, as does paper. If the reader becomes inattentive so that his gaze moves away while reading text presented on an RSVP display, several sentences might be lost before reading is resumed. Thus, RSVP places significant temporal and mental demands on the reader. The reader's eyes have to be constantly watching the display screen, and any distracting thoughts, which can easily occur during the reading of text, must be suppressed. Clearly, this is not the way that the human reading process functions. More typically, thoughts are constantly displaced by less clear and imprecise thoughts, and then brought back to focus again.

Another affordance provided by a paper document is that the reader can alter his reading speed automatically. Thus, he can increase or decrease the paper reading speed according to his own preferences, in order to optimize his reading performance. In the adaptive RSVP arrangement of the prior art, the reading speed is adapted to the varying reading pace of an average reader. However, there are significant individual differences in reading speed. If a reader using the adaptive RSVP arrangement wishes to change his reading speed level, he has to use a button or switch to decrease or increase the speed level. Clearly, in reading text on a paper document it is not necessary to use switches or other controls in order to change reading speed level. At present, a capability of automatically adjusting the speed at which reading takes place, in order to accommodate the individual needs of different readers, is generally not available in electronic RSVP reading devices.

### SUMMARY OF THE INVENTION

By means of the invention, adjustments for both inattention and variations of reading speed level are modeled, in a straight forward and beneficial way, into the RSVP electronic reading paradigm. More particularly, if the user of an RSVP text display device becomes inattentive so that his eyes are no longer focused on the text display window, text presentation is automatically paused or halted. Thereafter, when the reader's eyes again focus on the display window, text presentation is automatically resumed, usefully at the beginning of the last sentence previously read. Thus, it is not necessary to operate switches or other controls, in order to continually stop and restart text presentation, to compensate for periodic inattention.

In another aspect of the invention, as described hereinafter in further detail, feedback is provided in regard to eye movements of a reader in response to changes in reading speed. The feedback information is then used to adjust text presentation to a speed that matches the individual reader's mental progress.

In one embodiment, the invention is directed to a method for selectively adjusting the presentation of text in a device provided with an RSVP display window. The method comprises the steps of detecting a first orientation or point of gaze of a reader's eye with respect to a boundary of the window, and then detecting a change in the reader's point of gaze. Following detection of the change in point of gaze, text presentation is adjusted in a specified corresponding relationship to the detected change.

In a preferred embodiment of the invention, the detected change in the reader's point of gaze is from focusing on a point within the display window to focusing on a point outside the window, while text is being displayed upon the window. The adjustment then comprises halting presentation of text. Alternatively, the detected change in the reader's point of gaze is from a point of focus outside the window to a point of focus within the window, whereupon an adjustment is made to resume text presentation upon the display window.

In a useful embodiment, first and second points of gaze of the reader's eyes, with respect to a boundary of the window, are respectively detected by a selected number of eye tracking sensors positioned proximate to the window boundary. In another useful embodiment, the first and second points of gaze are determined, at least in part, by detecting the number of times the eyes of the reader blink during a specified period of time. The eye blink rate, or lack of eye blinks, can be used to indicate the comparative attention or inattention of the reader.

### BRIEF DESCRIPTION OF THE DRAWINGS

FIG. 1 is a simplified view showing an RSVP display disposed to operate in accordance with an embodiment of the invention.

FIG. 2 is a schematic diagram showing an eye tracking device for the RSVP display of FIG. 1.

FIG. 3 is a block diagram showing principal components of an embodiment of the invention.

FIG. 4 is a block diagram showing a modification of the embodiment depicted in FIG. 3.

FIGS. 5-7 are respective simplified views of an RSVP display illustrating a second modification of the embodiment depicted in FIG. 3.

FIG. 8 is a block diagram showing a further modification of the embodiment depicted in FIG. 3.

### DETAILED DESCRIPTION OF THE PREFERRED EMBODIMENT

Referring to FIG. 1, there is shown a mobile device 10, of the type described above, provided with a window 12 for displaying a text segment 14 on a single line. Text segment 14 is one of a number of segments which are sequentially or serially presented in display window 12, in accordance with the RSVP technique, to communicate a complete message. For illustration, segment 14 is the first of three segments collectively forming a simple message of only one sentence, described hereinafter in further detail. However, in accordance with the invention window 12 can be used to present segments of a message of virtually any length.

Referring further to FIG. 1, there is shown a boundary 16 positioned along respective edges of rectangular window 12. Boundary 16 comprises lines or markings which contrast with the surface of device 10. Accordingly, the lines of boundary 16 enable a reader or user of device 10 to readily focus his eye 18 upon the line of text within display window 12.

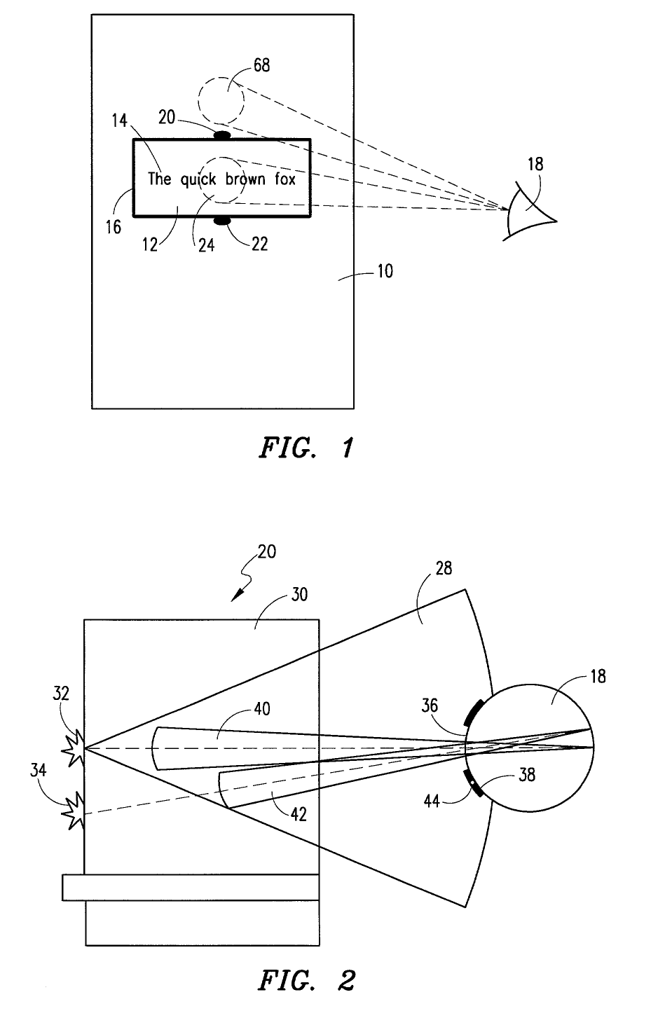

FIG. 1 further shows eye tracking sensors 20 and 22 located proximate to boundary 16, above and below window 12, respectively. Sensor 20 could, for example, comprise an eye tracking device developed by the IBM Corporation at its Almaden Research Center, which is referred to by the acryonm MAGIC and is described in further detail hereinafter, in connection with FIG. 2. This device is mounted proximate to a display screen, in a known positional relationship. When a user is viewing the screen, the IBM eye tracking device determines the point of gaze or focus, with respect to the screen, of the pupils of the user's eyes.

While the IBM tracking device may be employed as sensor 20, it is to be emphasized that sensor 20, for purposes of the invention, only needs to detect one of two states of the user's eyes. More specifically, it is only necessary to know whether the pupils of the user's eyes 18 are directed to a point of gaze 24, located within window 12 and thus focused upon text segments therein, or are directed to any location outside the window 12, such as to point of gaze 6826. It is to be emphasized further that any suitable device known to those of skill in the art which is capable of performing this two state detection task may be used for sensor 20.

It is anticipated that an embodiment of the invention could be implemented using only sensor 20. However, to enhance accuracy in determining whether or not a reader's eyes are focused within text window 12, the sensor 22 is also provided. Sensor 22 detects a characteristic of a reader's eyes which is different from the characteristic detected by sensor 20. For example, sensor 22 could be a device for monitoring a reader's eye blinks. Such information would be very useful where a steady rate of eye blinks indicates that a user is concentrating upon a task, whereas an absence of eye blinks indicates user inattention. Alternatively, an eye blink sensor could be used to control timing of text presentation, as described hereinafter. Consistent with the invention, other sensors known to those of skill in the art could be alternatively or additionally placed around boundary 16 to monitor other characteristics of a user's eyes which are pertinent to detecting whether or not a user is reading the text in window 12.

In the text display shown in FIG. 1, a key or switch (not shown) is used to initially turn on the display. Then, if sensor 20 and detected eye blinks indicate that the point of gaze of a reader is focused on the text in window 12, RSVP text presentation commences. Subsequently, if the sensors detect that the pupils of the reader are no longer focused on text window 12 (including no detection of eye blinks), the RSVP presentation is paused. Thereafter, if the sensor detects that the reader's pupils are again focusing on the text, presentation resumes.

It may be that a time delay, such as 100 milliseconds, will occur from the time a reader's point of gaze wanders away from the text window until text presentation is paused. In order to ensure that the reader does not miss any text segments, it may be useful to automatically rewind the text before presentation is resumed. Thus, if respective text segments are each presented for 35 milliseconds on the window 12, three segments would have been presented during the 100 millisecond time delay. Accordingly, these three segments should be presented again, starting with the first, when text presentation is resumed. Alternatively, resumption of text presentation could commence at the beginning of the sentence which was being displayed when presentation was paused or interrupted by the eye tracking sensors.

Referring to FIG. 2, there is shown an eye tracking device of a type developed by the IBM Corporation and referred to above, which may be adapted for use as the sensor 20. Such device generally comprises a TV camera 30 or the like, which has an imaging field 28 and acquires successive image frames at a specified rate, such as 30 frames per second.

The device further comprises two near infrared (IR) time multiplexed light sources 32 and 34, each composed of a set of IR light emitting diodes (LED's) synchronized with the camera frame rate. Light source 32 is placed on or very close to the optical axis of the camera, and is sychronized with even frames. Light source 34 is positioned off of the camera axis, and is synchronized with the odd frames. The two light sources are calibrated to provide approximately equivalent whole-scene illumination.

When the on-axis light source 32 is operated to illuminate a reader's eye 18, which has a pupil 36 and a cornea 38, the camera 30 is able to detect the light reflected from the interior of the eye, and the acquired image 40 of the pupil appears bright. On the other hand, illumination from off-axis light source 34 generates a dark pupil image 42. Pupil detection is achieved by subtracting the dark pupil image from the bright pupil image. After thresholding the difference, the largest connected component is identified as the pupil.

Once the pupil has been detected, the location of the corneal reflection 44 (the glint or point of light reflected from the surface of the cornea 3828 due to one of the light sources) is determined from the dark pupil image. A geometric computation is then performed, using such information together with a known positional relationship between sensor 20 and display window 12. The computation provides an estimate of a reader's point of gaze in terms of coordinates on the display window 12.

The eye tracker device disclosed above is described in further detail in a paper entitled Manual and Gaze Input Cascaded (Magic), S. Zhai, C. Morimoto and S. Ihde, In Proc. CHI '99: ACM Conference on Human Factors in Computing Systems, pages 246-253. Pittsburgh, 1999. However, it is by no means intended to limit the sensor 20 to the above device. To the contrary, it is anticipated that a number of options for sensor 20 will readily occur to those of skill in the art. Once again, it is to be emphasized that the sensor only needs to determine whether a reader's point of gaze is or is not focused on a location within the text window 12.

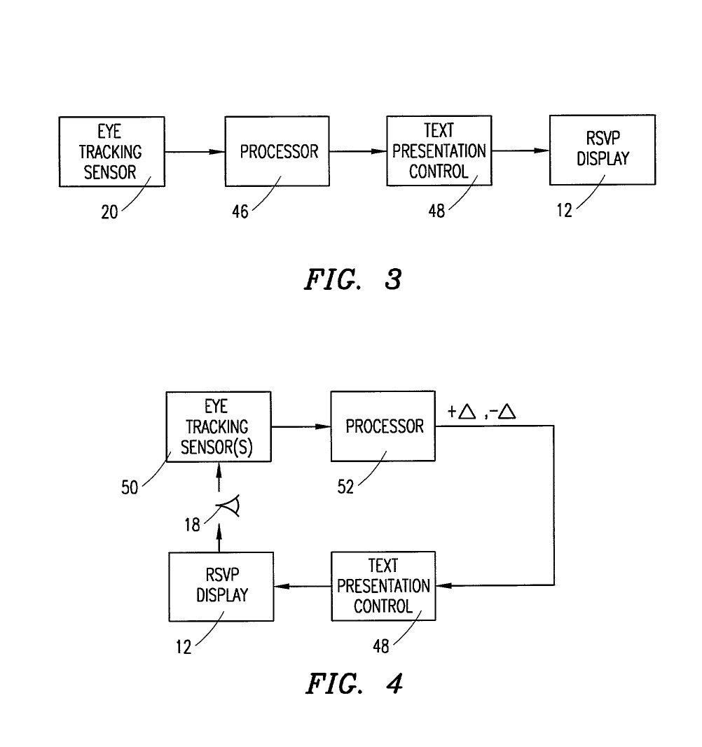

Referring to FIG. 3, there is shown a processor 46 contained within the device 10 to receive data pertaining to a reader's point of gaze, or orientation of the reader's eyes, from sensor 20. Upon receiving the data, processor 46 carries out the geometric computation described above to determine the direction of the reader's point of gaze. Such data is acquired by sensor 20 and coupled to processor 46 at selected short intervals. If processor 46 determines that the reader's point of gaze has moved out of the display window 12 since the last computation, processor 46 sends a signal to a text presentation control 48 to pause further presentation of text on the display window. Thereafter, processor 46 will signal control 48 to resume presentation, upon determining that the reader's point of gaze is again focused upon the text in window 12. Control 48 may also be directed to selectively rewind or back up the presented text, as described above.

While FIG. 3 shows processor 46 receiving data only from sensor 20, it could additionally receive data from sensor 22. Processor 46 would then employ the data from sensor 22 as well as the data from sensor 20 in making a determination about a reader's point of gaze.

Referring to FIG. 4, there is a shown a feedback arrangement wherein an eye-tracking sensor or sensors are disposed to detect characteristics of a reader's eyes as the reader views text on display window 12. More particularly, sensor or sensors 50 detect characteristics which indicate whether text is being presented at a pace or speed which is too fast or too slow for the reader. For example, continual rapid side-to-side movements of a reader's eyes, from right to left and back, could indicate that text was being presented to the reader too rapidly. On the other hand, a decreasing eye blink rate while the reader was viewing the display window could indicate that text presentation was too slow.

Referring further to FIG. 4, there is shown outputs of sensor 50 coupled to a processor 52. Upon detecting that the pace of text presentation is unsuitable for the reader, processor 52 couples a signal +Δ for a too slow condition or a −Δ for a too fast condition to text presentation control 48, to incrementally increase or decrease, respectively, the pace of text presentation on window 12.

Incremental adjustments of text presentation are continued until the sensors 50 no longer indicate that the pace is too fast or too slow.

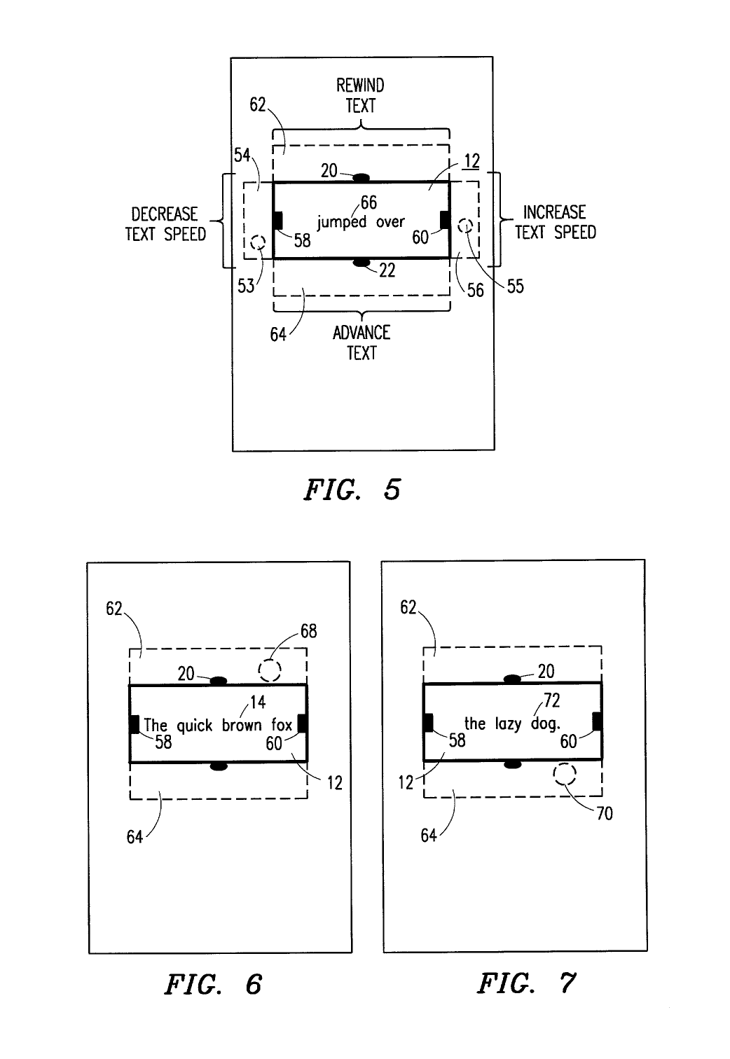

Referring to FIG. 5, there are shown zones 54 and 56 to the left and right, respectively, of window 12. When sensor 20 and processor 46, described above in connection with FIG. 3, determine that a reader's point of gaze 53 is located in zone 54, processor 46 directs text presentation control 48 to reduce the speed of text presentation. When the reader's point of gaze 55 is detected to be in zone 56, control 48 is directed to increase text speed. Thus, a reader can use deliberate eye movements to adjust the presentation times of successive text segments upon display window 12. Markings 58 and 60 are usefully placed along the sides of window 12, to assist a reader in focusing his gaze upon zones 54 and 56, respectively.

Referring further to FIG. 5, there are shown zones 62 and 64 directly above and below window 12, respectively. If a text segment 66 is being presented on window 12, and sensor 20 and processor 46 determine that a reader's point of gaze has shifted to zone 62, text presentation is rewound or adjusted to display the segment immediately preceding segment 66. This is illustrated in FIG. 6, which shows the reader's point of gaze 68 located in zone 62. Accordingly, window 12 is operated to present text segment 14, where segment 66 and segment 14 are the second and first segments, respectively, in a three segment message.

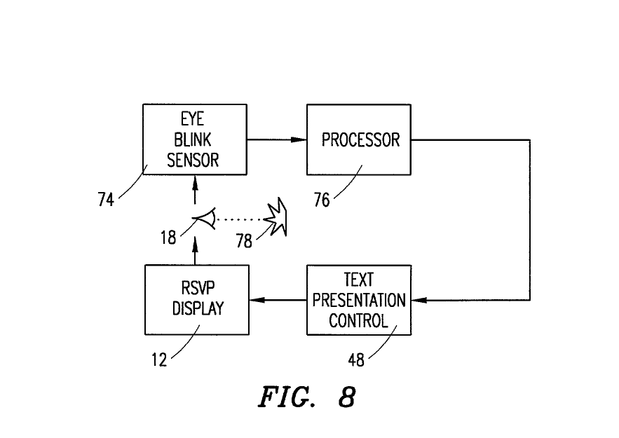

In similar fashion, if it is determined that the reader's point of gaze has shifted to zone 64, the text presentation is advanced to display the segment immediately following segment 66. This is illustrated in FIG. 7, which shows the reader's point of gaze 70 located in zone 64. Accordingly, window 12 is operated to present text segment 72, where segment 66 and segment 72 are the second and third segments, respectively, in the three segment message. Thus, a reader can use deliberate eye movements to rewind and advance presented text.

A further embodiment of the invention may be directed to a phenomenon known as attentional blink. This phenomenon can occur in an RSVP arrangement of the type described above if successive text segments are presented too closely together in time. More particularly, if detection of the letters of a first target segment cause a user of the is RSVP device to blink, the letters of the next following segment may effectively be invisible to the user, if they occur too quickly after the first segment letters. Moreover, a further component of attentional blindness may result from mental processing of the first text segment, if the processing is still continuing when the next following segment is presented on the display. The phenomenon of attentional blink is described in further detail, for example, in “Fleeting Memories: Cognition of Brief Visual Stimuli”, by Veronica Coltheart, MIT Press/Bradford Books Series in Cognitive Psychology, Cambridge, Mass. (1999), and particularly Chapter 5 thereof entitled “The Attentional Blink: A Front-End Mechanism for Fleeting Memories” by Kimron L. Shapiro and Steven J. Luck, pp. 95-118.

Referring to FIG. 8, there is shown an embodiment of the invention which is disposed to detect an attentional blink condition and to make adjustments therefor. The embodiment of FIG. 8 is provided with an eye blink sensor 74, which detects eye blinks of a reader's eyes 18. Upon detection of an eye blink, sensor 74 sends a signal to processor 76, whereupon processor 76 slows down the text presentation speed. More particularly, processor 76 operates text presentation control 48 to increase the exposure or display time of the text segment which occurs during or after the eye blink. The eye blink rate of a reader may also be detected, in order to provide data for use in predicting the time at which an eye blink will occur, following a previously detected eye blink.

As a further enhancement, the embodiment of FIG. 8 could be provided with a device for producing light flashes 78 or the like, to deliberately trigger successive eye blinks. Eye blinks would then occur at times which were reliably known. The text segment which immediately followed an induced eye blink would be provided with increased exposure time, thereby preventing attentional blindness.

Obviously, many modifications and variations of the present invention are possible in light of the above teachings. It is therefore to be understood that within the scope of the disclosed concept, the invention may be practice otherwise than as has been specifically described.

What is claimed is:

1. In a device provided with an RSVP display window for presenting text to a reader, a method for selectively adjusting said presentation of text comprising:
detecting a first point of gaze of said reader with respect to a boundary of said window;
detecting a change in the point of gaze of said reader with respect to said boundary, from said first point of gaze to a second point of gaze; and
following detection of said change in point of gaze, adjusting said text presentation in specified corresponding relationship with said change.

2. The method of claim 1 wherein:
said change detecting step comprises detecting change from a first point of gaze wherein said reader's eyes are focused upon a point within said boundary, to a second point of gaze wherein said reader's eyes are focused upon a point outside of said boundary, said text being displayed upon said window when said change is detected; and
said adjustment comprises halting presentation of text upon said window.

3. The method of claim 1 wherein:
said change detecting step comprises detecting change from a first point of gaze wherein said reader's eyes are focused upon a point outside of said boundary, to a second point of gaze wherein said reader's eyes are focused upon a point within said boundary, text not being displayed upon said window when said change is detected; and
said adjustment comprises commencing presentation of text upon said window.

4. The method of claim 1 wherein:
said change detecting step comprises detecting change from a first point of gaze wherein said reader's eyes are focused upon a point within said boundary, to a second point of gaze wherein said reader's eyes are focused upon a zone positioned outside of said boundary in specified adjacent relationship; and
said adjustment comprises selectively varying the speed level at which said text is presented upon said display window.

5. The method of claim 1 wherein:
said change detecting step comprises detecting change from a first point of gaze wherein said reader's eyes are focused upon a point within said boundary, to a second point of gaze wherein said reader's eyes are focused upon a zone positioned outside of said boundary in specified adjacent relationship; and
said adjustment comprises presenting a text segment which was previously presented upon said display.

6. The method of claim 1 wherein:
said change detecting step comprises detecting change from a first point of gaze wherein said reader's eyes are focused upon a point within said boundary, to a second point of gaze wherein said reader's eyes are focused upon a zone positioned outside of said boundary in specified adjacent relationship; and
said adjustment comprises advancing said text presentation to present a subsequent text segment in an associated message.

7. The method of claim 1 wherein:
the eye blink rate of said reader is detected to provide data for use in detecting said change in point of gaze.

8. The method of claim 1 wherein said method further comprises:
detecting an eye blink of said reader; and
selectively increasing the presentation time of the text segment immediately following said eye blink.

9. The method of claim 1 wherein:
the eye blink rate of said reader is detected to provide data for use in predicting the time at which an eye blink will occur, following a previously detected eye blink.

10. The method of claim 1 wherein:
data pertaining to a specified characteristic of said reader's eyes is acquired over a period of time; and
said acquired data is used to adjust the speed of said text presentation in relationship to the reading speed of said reader.

11. In a device provided with an RSVP display window for presenting text to a reader, said window having a boundary, apparatus for selectively adjusting said presentation of text comprising:
a sensor for detecting changes in orientation of a reader's eyes between a first point of gaze, wherein said reader's eyes are focused within said boundary, and a second point of gaze, wherein said reader's eyes are focused outside of said boundary; and
a control responsive to said sensor and coupled to said display for selectively adjusting said text presentation in response to detection of a particular change in the orientation of said reader's eyes between said first and second points of gaze.

12. The apparatus of claim 11 wherein:
said control halts presentation of text upon said window when said sensor detects a change in said orientation from said first point of gaze to said second point of gaze.

13. The apparatus of claim 11 wherein:
said control commences presentation of text upon said window when said sensor detects a change in said orientation from said second point of gaze to said first point of gaze.

14. The apparatus of claim 11 wherein:
said control changes the speed of text presentation on said display window when said sensor detects a change from said first point of gaze to said second point of gaze, wherein for said second point of gaze said reader's eyes are focused outside of said boundary and within a specified zone which is adjacent to said boundary.

15. The apparatus of claim 11 wherein:
said control changes the text presented on said display window from a first text segment to a second text segment of a message when said sensor detects a change from said first point of gaze to said second point of gaze, wherein for said second point of gaze said reader's eyes are focused outside of said boundary and within a specified zone which is adjacent to said boundary.
